(19) United States
(12) Patent Application Publication
(10) Pub. No.: US 2002/0114054 A1
(43) Pub. Date: Aug. 22, 2002

(54) Optical element and method of manufacturing such an optical element

(75) Inventors: Gerardus Henricus Rietjens, Eindhoven (NL); Thomas Nicolaas Maria Bernards, Eindhoven (NL); Martinus Petrus Joseph Peeters, Eindhoven (NL); Gosse Charles De Vries, Eindhoven (NL); Pieter Johannes Werkman, Drachten (NL); Johannes Maria Azalina Antonius Compen, Eindhoven (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/055,384

(22) Filed: Jan. 22, 2002

(30) Foreign Application Priority Data
Feb. 19, 2001 (EP) 01200595.5

(51) Int. Cl. G02F 1/03; G02F 1/07

(52) U.S. Cl. 359/241; 359/242

(57) ABSTRACT

The invention relates to an optical element comprising a substrate which is provided with a transparent layer comprising an organic polymer network and one or more photochromic compounds, in which the transmission of the optical element in the visible wavelength range changes in response to a variation of incident light, while the transparent layer comprising photochromic compounds is provided with a protective coating on the side remote from the substrate side.

The invention relates to an optical element comprising a substrate which is provided with a layer comprising an organic polymer and one or more photochromic compounds, in which the transmission of the optical element in the visible wavelength range changes in response to a variation of incident light.

The invention also relates to a method of manufacturing such an optical element.

Optical elements which can vary the transmission of light are used, for example, for influencing the transmission and/or reflection of (visible) light, for example, in lamps, rear view mirrors and car sunroofs, or windows for buildings (“smart windows”), or of spectacle glasses. Such optical elements are also used on the viewer-facing side of display screens of (flat-panel) display devices such as cathode ray tubes (CRTs), plasma display panels (PDPs), liquid crystal displays (LCDs, LC-TVs and plasma-addressed LCDs) and electroluminescent displays (LED displays, organic or polymer LED displays) for improving the contrast of the displayed image.

It is favorable, particularly for the image quality, that the contrast can be adapted and optimized dependent on the illumination intensity of the ambient light. This optimization is not possible by means of a fixed value for the transmission of the display screen, which value depends, for example, on the composition of the glass of the display screen. The above-mentioned layers influence the intensity of both the reflected ambient light and the light coming from an (internal) light source, for example, phosphor in a cathode ray tube. The incident ambient light passes through the layer and is reflected on the substrate whereafter the reflected layer again passes through the layer. If the transmission of the layer is denoted as T, the intensity of the reflected ambient light subsequently decreases by a factor of T². The light coming from the internal light source passes through the layer only once so that the intensity of this light only decreases by a factor of T. The combination of these effects causes the contrast to be inversely proportional to T, or in other words, a lower transmission yields a better contrast at a lower luminance of the image, and vice versa.

Examples of optical elements for varying the transmission of light comprise, inter alia, electrochromic elements and photochromic elements.

The transmission of an optical element provided with a layer comprising photochromic compounds automatically varies as a result of electromagnetic radiation, for example, light such as sunlight which is directly or indirectly incident on the layer. A large number of photochromic compounds is known and may be divided into different classes (for example, spiropyrane compounds, spiro-oxazines or fulgides). Such an optical element provides the possibility of, for example, increasing the contrast of an image by using a layer comprising photochromic compounds on the display screen of a display device.

Such an optical element is known per se from international patent application WO 98/30923 in the name of the applicant. The “transparent” layer known from this application comprises an inorganic network of a silicon oxide in which the layer also comprises an organic polymer which is chemically bound to the inorganic network via Si—C bonds. The network also incorporates macroscopic particles of a metal oxide chosen from the group of Al, Si, Ti, Zr, In and Sn. Generally, such optical elements are manufactured via the wet-chemical sol-gel route. A sol-gel process is a method in which, due to the controlled addition of water, a solution of alkoxysilane in alcohol is subsequently subjected to a hydrolysis and polycondensation treatment so that an inorganic network of silicon (di)oxide is formed. The inorganic network thus formed is condensed by performing a thermal treatment in which the formation of silicon oxide is completed. A three-dimensional inorganic network is thus formed during the sol-gel process.

The optical elements as described in patent application WO 98/30923 have the drawback that they constitute a compromise between good mechanical (scratch-proof) and optical properties (switching behavior of photochromic compound).

It is an object of the present invention to provide an optical element having an optimal display which is rich in contrast, particularly, when the illumination level of the ambient light varies within a wide range and within a short period of time.

It is another object of the present invention to provide an optical element having very good mechanical properties, notably the fact that the optical element is scratch-proof.

This object is achieved by means of an optical element according to the present invention which is characterized in that the transparent layer comprising photochromic compounds is provided with a protective coating on the side remote from the substrate side.

In principle, a photochromic layer on an optical element must satisfy two contradictory conditions: a) the network must have good mechanical properties such as a good adhesion, wear resistance and scratch resistance, which leads to a hard and rigid network, and b) the network must allow the used photochromic materials to have a good switching behavior and response to incident light, which can be achieved by means of soft flexible matrices.

By using a protective coating on the transparent layer comprising photochromic compounds, the inherent drawbacks of the optical element according to WO 98/30923 are eliminated. The mechanical function is performed by the protective coating and the optical function is performed by the transparent layer comprising photochromic compounds. By separating the mechanical and optical functions, an optical element is obtained which satisfies the above-mentioned objects.

The term “protective coating” used in this patent application should be understood to be a layer constituting a physical protection from the transparent layer comprising photochromic compounds. A faceplate, a foil or a scratch-proof layer are examples of such a protective coating.

There are various possibilities of using a protective coating. One possibility is the lamination of a faceplate which is made of, for example glass and functions as a protective coating. A layer comprising an organic polymer and one or more photochromic compounds is present between the faceplate and the optical element.

Another possibility is to laminate a foil comprising an organic polymer and one or more photochromic compounds, which foil has a hard coating on at least one side, for example, a hard silicon oxide coating. The foil is laminated on the optical element in such a way that a protective coating in the form of a hard coating is provided on the side remote from a substrate side.

An extra advantage of laminating a foil or a faceplate is that it gives the optical element very good mechanical properties. A laminated foil or faceplate in combination with a substrate, particularly a cathode ray tube, increases the strength of the substrate and yields a better protection against implosion of the cathode ray tube.

It is notably preferred to have the optical element optically coupled to both the substrate and the protective coating. Specular reflections are thereby counteracted, notably when the difference of refractive index between the layer comprising photochromic compounds and the protective coating and the substrate is smaller than 0.1.

It is notably preferred to use photochromic compounds which switch actively, i.e. discolor from a transparent state to an absorbing state, by means of incident light in the wavelength range between 320 and 400 nm. If the optical element is a display screen, it is preferred not to switch the photochromic compounds by means of light generated by the display screen itself. Generally, a display screen mainly generates light in the wavelength range of visible light which is mainly between 400 and 800 nm. To ensure that the photochromic compounds do not switch by means of light generated by the display screen itself, it is preferred to use a photochromic compound which switches under the influence of light having a wavelength outside the wavelength range of visible light, preferably in the wavelength range between 320 and 400 nm.

According to the invention, a method of manufacturing an optical element as described hereinbefore is characterized in that one or more photochromic compounds are mixed with one or more compounds which can be polymerized, whereafter the mixture obtained is provided in a space enclosed by the protective coating and the substrate and is subsequently subjected to a polymerization treatment for forming the transparent layer comprising photochromic compounds.

In accordance with such an embodiment, the photochromic compounds are present as discrete domains in a polymer matrix which is notably suitable for incorporating one or more photochromic compounds allowing short switching periods.

The protective coating is preferably a faceplate which is preferably made of glass.

It is further possible that the method of manufacturing an optical element is performed in such a way that one or more photochromic compounds are mixed with one or more compounds which can be polymerized, whereafter the mixture obtained is provided on the protective coating and is subsequently subjected to a polymerization treatment, whereafter the obtained assembly of protective coating and transparent layer comprising photochromic compounds is provided on the substrate in such a way that the transparent layer comprising photochromic compounds engages the substrate.

It is further possible that the method of manufacturing the optical element is performed in such a way that, after performing the polymerization treatment, an intermediate layer is provided on the obtained assembly of protective coating and transparent layer comprising photochromic compounds, which intermediate layer engages the transparent layer comprising photochromic compounds, whereafter the obtained assembly of protective coating, the layer comprising photochromic compounds and the intermediate layer is provided on the substrate in such a way that the intermediate layer engages the substrate.

In a particular embodiment of the method, it is further possible that a polymer film is provided in a solution in which one or more photochromic compounds are present, the photochromic compounds diffusing in the polymer film and the polymer film being subsequently removed from the solution, while the polymer film thus formed is used as the transparent layer comprising photochromic compounds.

In a particular embodiment of the invention, the method of manufacturing an optical element is performed in such a way that one or more polymers and one or more photochromic compounds are mixed in a mixing means for forming the transparent layer comprising photochromic compounds.

The invention will now be described with reference to a number of examples.

However, it should be noted that the specific examples are only given for explanatory purposes.

### EXAMPLE 1

A mixture of 100 parts by weight of PEGDMA550 (polyetheneglycoldimethacrylate having a molecular weight of the monomer of approximately 500), 0.5 part by weight of LTPO (2,4,6-trimethylbenzoyldiphenylphosphine oxide, a photoinitiator marketed by BASF) and 0.1 part by weight of MXP7-114 (a photochromic naphtopyrane, marketed by PPG industries) was poured into a space enclosed by the protective coating and the substrate. After the enclosed space thus filled, also referred to as “cell”, had been sealed, the cell was irradiated with UV light (intensity: 3 mW/cm²) for about 10 minutes. After performing the photopolymerization process, a system comprising photochromic compounds and having short switching periods (coloration/discoloration periods<2 minutes) was obtained. In accordance with this method, samples having a thickness of 3 mm can be made. Experiments proved that samples thus made had transmission values varying between about 5% and about 45% for light having a wavelength of 570 nm, after illumination with UV light at 15° C. and 40.5° C., respectively. Under dark circumstances, the samples had a transmission value of approximately 96% at 570 nm, irrespective of the temperature.

### EXAMPLE 2

The same mixture as used in example 1 was provided by means of spin coating on a glass protective coating. The glass protective coating was irradiated with UV light (intensity: 3 mW/cm²) for about 10 minutes in a nitrogen atmosphere. After the photopolymerization process had been terminated, a protective coating was obtained which was provided with a transparent layer comprising photochromic compounds. The samples thus obtained had the same transmission values as mentioned in example 1.

### EXAMPLE 3

The same mixture as used in examples 1, 2 was used, except that 0.5 part by weight of LTPO was replaced by 0.5% by weight of AIBN (azobis-isobutyronitryl, a thermal catalyst marketed by Aldrich). The mixture thus prepared was provided by means of spin coating on a glass protective coating, which was introduced into an oven in a nitrogen atmosphere. After the oven was rinsed with nitrogen gas for 10 minutes, the temperature in the oven was gradually increased to 65° C., while the time spent in the oven was about 18 hours. After the polymerization process, a protective coating provided with a transparent layer comprising photochromic compounds was obtained, which protective coating had short switching periods (<2 minutes). The samples thus obtained had the same transmission values as in example 1.

### EXAMPLE 4

This example provides a method of diffusing a photochromic compound in a polymer film. A poly(vinylbutyral) (PVB) film was swollen with a saturated solution of the photochromic dye Photosol7-14 in ethanol, and the film was subsequently dried in air. The laminate was subsequently manufactured by putting the doped PVB film between the substrate and the glass plate (transparent layer) and by compressing the assembly at 60° C. at a pressure of 100,000 Pa for 1 hour.

In summary, the invention relates to an optical element comprising a substrate which is provided with a transparent layer comprising an organic polymer network and one or more photochromic compounds, in which the transmission of the optical element in the visible wavelength range changes in response to a variation of incident light, while the transparent layer comprising photochromic compounds is provided with a protective coating on the side remote from the substrate side.

1. An optical element comprising a substrate which is provided with a transparent layer comprising an organic polymer and one or more photochromic compounds, in which the transmission of the optical element in the visible wavelength range changes in response to a variation of incident light, characterized in that the transparent layer comprising photochromic compounds is provided with a protective coating on the side remote from the substrate side.

2. An optical element as claimed in claim 1, characterized in that the difference of refractive index between the transparent layer comprising photochromic compounds and the protective layer is smaller than 0.1.

3. An optical element as claimed in claims 1 and 2, characterized in that the difference of refractive index between the transparent layer comprising photochromic compounds and the substrate is smaller than 0.1.

4. An optical element as claimed in claims 1 to 3, characterized in that the photochromic compounds switch actively by means of incident light in the wavelength range between 320 and 400 nm.

5. A method of manufacturing an optical element as claimed in claims 1 to 4, characterized in that one or more photochromic compounds are mixed with one or more compounds which can be polymerized, whereafter the mixture obtained is provided in a space enclosed by the protective coating and the substrate and is subsequently subjected to a polymerization treatment for forming the transparent layer comprising photochromic compounds.

6. A method of manufacturing an optical element as claimed in claims 1 to 4, characterized in that one or more photochromic compounds are mixed with one or more compounds which can be polymerized, whereafter the mixture obtained is provided on the protective coating and is subsequently subjected to a polymerization treatment, whereafter the obtained assembly of protective coating and transparent layer comprising photochromic compounds is provided on the substrate in such a way that the transparent layer comprising photochromic compounds engages the substrate.

7. A method of manufacturing an optical element as claimed in claim 6, characterized in that, after performing the polymerization treatment, an intermediate layer is provided on the obtained assembly of protective coating and transparent layer comprising photochromic compounds, which intermediate layer engages the transparent layer comprising photochromic compounds, whereafter the obtained assembly of protective coating, the layer comprising photochromic compounds and the intermediate layer is provided on the substrate in such a way that the intermediate layer engages the substrate.

8. A method of manufacturing an optical element as claimed in claims 1 to 4, characterized in that a polymer film is provided in a solution in which one or more photochromic compounds are present, the photochromic compounds diffusing in the polymer film and the polymer film being subsequently removed from the solution, while the polymer film thus formed is used as the transparent layer comprising photochromic compounds.

9. A method of manufacturing an optical element as claimed in claims 1 to 4, characterized in that one or more polymers and one or more photochromic compounds are mixed in a mixing means for forming the transparent layer comprising photochromic compounds.

10. A display screen of a display device, the display screen comprising an optical element as claimed in claim 1, 2, 3 or 4.
